(19) United States
(12) Patent Application Publication
(10) Pub. No.: US 2010/0242527 A1
(43) Pub. Date: Sep. 30, 2010

(54) REFRIGERATED CONTAINER FOR SHIPS

(76) Inventors: Ole Thogersen, Nyborg (DK); Allan Dyrmose, Bogense (DK)

Correspondence Address: QUARLES & BRADY LLP, 411 E. WISCONSIN AVENUE, SUITE 2040, MILWAUKEE, WI, 53202-4497, US

(21) Appl. No.: 12/665,414

(22) PCT Filed: Jun. 19, 2008
(86) PCT No.: PCT/EP08/04954

§ 371 Date: May 26, 2010

(30) Foreign Application Priority Data
Jun. 22, 2007 (DE) 10 2007 028 788.9
Jun. 22, 2007 (DE) 20 2007 008 764.0

(51) Int. Cl. F25D 31/00; F17C 13/00

(52) U.S. Cl. 62/455; 62/457.9

(57) ABSTRACT

The invention relates to a refrigerated container for ships, the inside of the rear side of said refrigerated container having formed in it a chute extending vertically and largely over the width of the container and featuring a transverse wall above which warmed refrigerated air which is collected beneath the roof area of the container can be supplied to the chute with downward deflection, wherein at least one port with an inserted annular part is formed in the transverse wall, and the warmed refrigerated air can be conducted to heat exchangers surfaces of an evaporator of a refrigerant circuit, said heat exchange surfaces projecting into the chute, via a blower through the flow cross section of said annular part, and wherein the refrigerated air cooled down by heat exchanger surfaces can be conducted back into the floor area of the refrigerated container from the bottom of the chute. In accordance with the invention flow directors for the warmed refrigerated air drawn in by the blower are provided above and to the side of the transverse wall, in order to laterally direct said warmed refrigerated air into the flow cross section of the annular part (40).

The invention relates to a refrigerated container for ships.

Such containers are basically shaped rectangular with a longitudinal axis 40 feet (roughly 14 m) long, for example. They are generally located on the vehicle so that the longitudinal axis of the container is parallel to the longitudinal axis of the vehicle.

The door of the container is arranged at one end whilst the other end mounts a refrigerating unit inserted through a cutout. As a rule the refrigerating unit is mostly releasably bolted to a flange surrounding the outer edge of the cutout.

The internal floor of the container is longitudinal ribbed forming longitudinal channels for conducting refrigerated air. The tops of the longitudinal ribs conventionally forming an upright tee supporting the cargo of the container.

In the region of the end door, means are provided to ensure that the refrigerated air since having become warmed by the cargo ascends, where not having already done so earlier through the cargo, to the roof of the container. A level mark, or some other means of regulating the height of the cargo is provided so that the warmed air between the cargo and the roof of the container can be returned to the end of the container opposite the end door and thus to the refrigerating unit.

The refrigerating unit forms a vertical chute on the inside of the corresponding end of the container, the chute extending the circulation of the refrigerated air, as described above, to form a closed circuit.

Protruding into the chute are the heat exchanger surfaces of an evaporator of a refrigerant circuit. The refrigerant circuit has a conventionally structure typically comprising in addition to the evaporator a compressor, a condenser and an expansion means connecting the evaporator in the cited sequence in the closed circuit.

The chute is usually covered, rendered permeable to air, for example, by means of an aluminum sheet metal sieve doubling as a safety guard against foreign objects falling in and injury due to unwanted human access. Remaining between this cover, the inner wall surfaces of the front wall and of the container is a plenum open to the storage space of the container within which the return flow of warmed refrigerated air is deflected through the cover into the chute. This plenum extends substantially, or practically completely, over the full width of the container.

Below the cover, clearly spaced away therefrom vertically, the chute is divisioned by a transverse wall in which a port is configured conventionally asymmetrically as a round hole relative to the container extending downwards for the warmed refrigerated air. However, in special instances it is just as possible that merely one, or several ports are provided.

Inserted in each port in the transverse wall is an annular part clasping the transverse wall by an outer flange-type structure on which it is located and expediently secured, the annular part porting the transverse wall to serve as an air feeder to an axial blower in each case. The axial blower directs the ascending warmed refrigerated air to the heat exchanger surface of the evaporator. This results in the heat of the ascending warmed refrigerated air being given off to the refrigerant of the refrigerant circuit, and the refrigerated air, now again suitable for refrigeration, is returned into the longitudinal channels in the floor of the container.

Attempts were made earlier to optimize use of the space available in the refrigerating unit and particularly in its chute by a simple design, especially by selecting the flow porting cross-section of the annular part for the ascending warmed refrigerated air as large as possible. But the maximum diameter thereof is dictated by the spacing between the inner surface of the end of the container opposite the end door and the adjoining wall surface opposite the cargo and the inner dimensions of the chute derived therefrom. This is why hitherto the outer flange-type structure of the annular part was configured on both sides thereof but not in the axial direction of the container so as not to restrict in this axial direction of the container the flow cross-section of the inner opening of the annular part.

The invention is based on the object to further improve the efficiency in refrigerating the cargo of the refrigerated container by a simple design.

This object is achieved by the features of claim 1.

Comparative test have shown that these aspects alone have made it possible to significantly increase efficiency which, depending on the practical application concerned, can be put to use for a variety of objectives including lower consumption of energy needed to power electric axial blowers, smaller power stages for the motors driving the axial blower as well as an improved throughflow of the cargo with refrigerated air. It was discovered in particularly that refrigeration, also transversely in the container, is now more uniform than previously. The explanation for this surprising effect is that refrigerated air in the side regions of the cargo space of the container is now circuited better than before by being held back less than before by becoming more or less tacked to the side wall. The flow profile in the return stream of the warmed refrigerated air is now less axialized, in other words more uniform.

As it reads from claim 2, introducing the warmed refrigerated air can be rendered uniform in the flow cross-section of the annular part which also reduces the noise developed, these effects being achieved even more so as it reads from claim 3, one special advantage thereof being a better capture of the more radially removed warmed refrigerated air.

As it reads from claim 4 it can now be avoided, or at least diminished, that free edges of the lateral flow directors as obstacles protruding into the inflow of warmed refrigerated air cause turbulence. This effect, as it reads from claim 5 is now further reduced in avoiding dead spaces in the flow whilst simultaneously making it possible to attain a flange-type support of the annular part at the transverse wall of the chute at least punctiform in the outer region of the annular part.

Claim 6 is based on the idea of arranging the flow directors and, where possible, the flange-type supports so that they now no longer take up valuable space as needed for accommodating the cargo.

Claim 7—where expounding on the idea of claim 6—becomes especially significant when the diameter of the flow cross-section in the annular part between the inner side of the front wall of the chute facing the cargo space and the front surface of the rear wall of the container is selected as large as possible.

Conventionally, annular parts consist of a cylindrical sleeve, from the top of which a sub-portion of the annular flange projects at right angles on both sides for securing to the transverse wall, the flow cross-section of this sleeve being circular. Such a circular inner cross-section is also preferred in the scope of the invention, particularly in the configuration as set forth in claim 7. But this does not exclude the sleeve part having a cross-section other than circular not only in conjunction with claim 7 but in the scope of the invention. Especially interesting in this case are flattened flow cross-sections preferably with a curved, for example, oval inner contour, the flattening expediently extending transversely in the chute to avoid influencing cargo space availability.

Claim 8 shows how the invention is achievable particularly simply by a modified integral annular part featuring a few constructive means, resulting in a surprisingly significant increase in efficiency for the same application as in the known case.

The known cylindrical annular part is usually made of aluminum or an aluminum alloy. In the scope of the invention even a thin-walled injected molded plastics material may be provided as it reads from claim 9 since the three-dimensional outer geometry resulting in conjunction with the flow directors also renders a thin-walled insertion sleeve in the transverse wall adequately dimensionally stable (see claim 10).

The features of claim 11 are known as such, but the significance of claim 11 is that a two-stage blower powered without gearing can now be employed in the scope of the invention as a particularly straightforward solution.

Basically any known type of blower can be put to use in the scope of the invention, for example, also a radial blower which, however, involves special adapters and thus, in the scope of the invention, preference is given to using an axial blower as is known.

One such axial blower is, however, expediently further adapted in the scope of the invention to further boost the performance efficiency by minor changes in shape.

Axial blowers as used conventionally have straight blades becoming thicker towards the shaft simply for stabilization. Instead, in accordance with the invention, preference is given as set forth in claim 13—preferably with the special features as set forth in claims 14 to 18—to a shaping serving not only to enhance the dimensional stability of the blades but, where necessary, also effecting their thickness.

It is especially the driving power of the corresponding blower and the noise it develops that are further reduced. Also contributing to such positive effects is the fact that the warmed refrigerated air forwarded by the blades of the axial blower is now received by the corresponding blade radially to radially outwards with some time delay.

Claim 19 firstly recites in its own preamble a restriction to the taken-over features of conventional annular parts. In the further development as it reads from claim 19 and the preferred further aspects thereof as set forth in claims 20 and 21 the preferred embodiment of an annular part used in the scope of the invention is detailed. Configuring a flange structure in accordance with the invention for supporting and, where necessary, securing the annular part to the transverse wall of the shaft is achieved in that the flow directors are now arranged in the radial inner space to the side of the sleeve part, where possible, as claimed in claim 21, along the whole axial extent of the inner cross-section of the chute to maximize the flow whilst being directly connected to the front side of the rear wall of the container with a continuation in a corresponding side flange structure radially further outwards back in the direction of the transverse wall, this flange structure being resolved tongued to advantage.

The surprising boost in the efficiency simply by replacing the conventional annular part—as also used by the applicant hitherto—by an annular part in accordance with the invention as detailed by the example configurations will now become clear from a discussion of the following trial comparisons.

These trial comparisons demonstrate, for one thing, quantitively to what degree especially the power consumption (wattage) of an electric powered axial blower can be altered by the modification of the annular part in accordance with the invention simply by replacing the known annular part by the novel one.

For another thing, there is also an interaction with the geometry especially of the blades of the axial blower for which no systematic trial comparison results are available at this time.

The axial blower was operated in the trial comparisons still with straight blades pitched 19, 22 and 25 degrees (standard).

In all cases the motor powering the axial blower was an electric gearless motor switched two and four pole for low and high speed respectively.

Trial Results

| | | | |
|---|---|---|---|
| conventional, | | | |
| pitch 25 | novel, | novel, | novel, |
| (Standard) | pitch 19 | pitch 22 | pitch 25 |

Power consumption: wattage

| | | | | |
|---|---|---|---|---|
| 60 hz fast | 1657 | 985 | 1280 | 1430 |
| 60 hz slow | 375 | 228 | 265 | 285 |
| 50 hz fast | 1008 | 617 | 800 | 870 |
| 50 hz slow | 283 | 181 | 204 | 213 |

m3/hour air flow

| | | | | |
|---|---|---|---|---|
| 60 hz fast | 5625.06 | 5420.76 | 6209.36 | 6428.64 |
| 60 hz slow | 2906.51 | 2615.58 | 3132.60 | 3234.75 |
| 50 hz fast | 4791.52 | 4459.19 | 5239.61 | 5435.47 |
| 50 hz slow | 2397.12 | 2141.06 | 2557.02 | 2651.81 |

This already makes it evident that the power consumption of the axial blower can now be reduced by 13 to 40% even without taking into account any adaptation of the blade geometry of the axial blower in the high speed mode (460 V, 60 Hz).

The invention will now be detailed by way of an example embodiment with reference to the diagrammatic drawings in which:

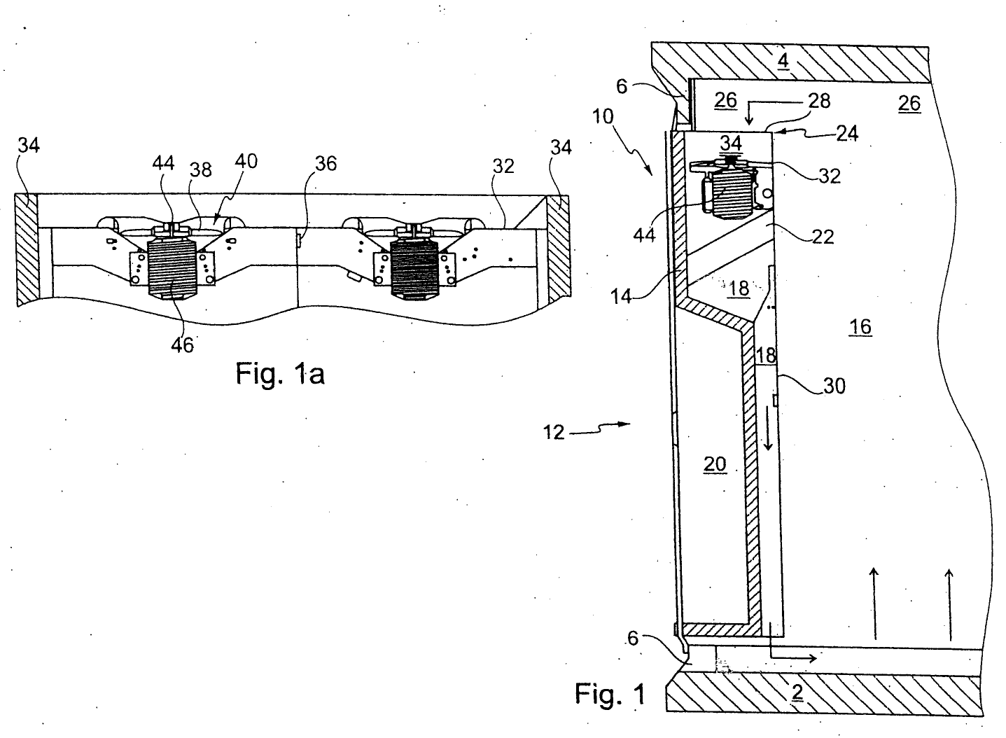

FIG. 1 is a partial section view of the rear end portion of a container along its longitudinal axis;

FIG. 1a is a partial section view at the same level as in FIG. 1 but at right angles to the transverse direction of the container;

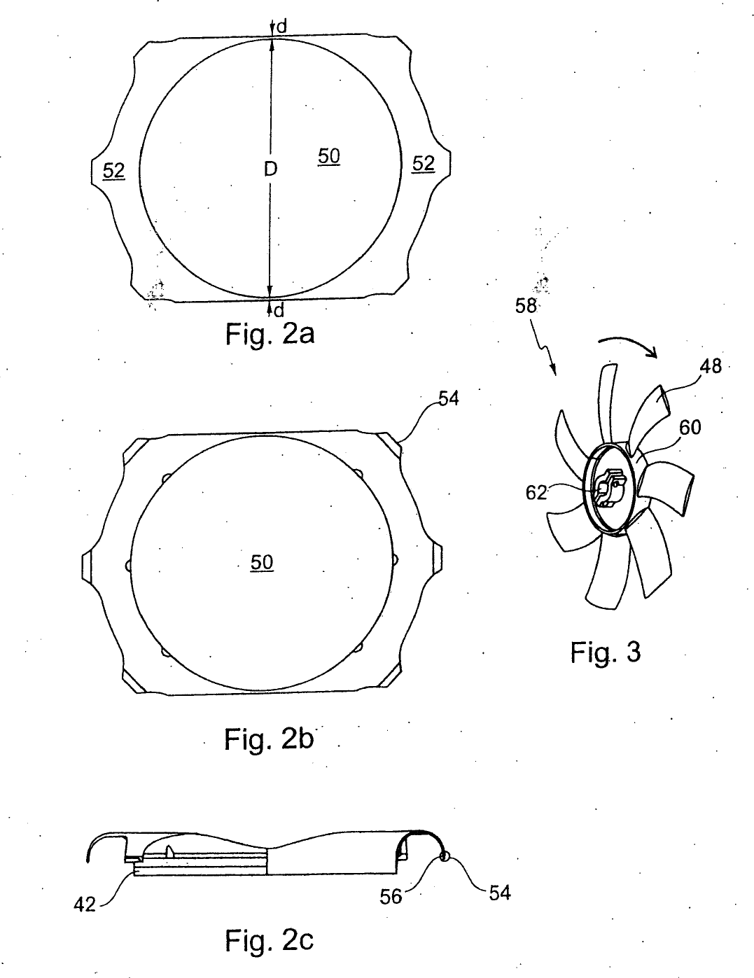

FIG. 2a is a top-down view;

FIG. 2b is a bottom-up view;

FIG. 2c is a side view of an annular part as employed in the assembly as shown in FIGS. 1 and 1a; and

FIG. 3 is an isometric view of the blade ring of an axial blower likewise employed in the assembly as shown in FIGS. 1 and 1a.

Referring now to FIG. 1 there is illustrated how the end portion of a container includes the floor panel 2, the roof panel 4 and the rear wall 6 thereof. The top of the floor panel 2 is ribbed in the longitudinal direction of the container, channels (not shown) being formed between the ribs for directing refrigerated air.

The rear wall 6 comprises practically over its full height and likewise more or less over its full width a cutout 10 through which a refrigerating unit 12 is inserted into the interior of the container.

The outer wall 14 of the refrigerating unit 12 is a functional extension of the rear wall 6 of the container as can be deemed functionally identical therewith.

Facing the cargo space 16 of the container in this arrangement the refrigerating unit 12 forms a vertical chute down which warmed refrigerated air is directed to the refrigerating unit 12 at the rear side of the container. Axially the lower portion of the chute 18 is tapered to create in line with the outer side of the rear wall 6 of the container a housing space 20 for the main function elements of the refrigerating unit 12. In the upper portion of the chute of sole interest in the scope of the invention the chute 18 is flared up to the inner side of the outer wall 14 of the refrigerating unit 12 which, as mentioned, takes on the function of the rear wall of the container.

The function elements of the refrigerating unit arranged in the housing space 20 are conventional, i.e. compatible with any known assembly, but of interest for the invention is that the heat exchanger surfaces 22 of an evaporator of the refrigerating unit protrude into the flared portion of the chute 18.

At the heat exchanger surfaces 22 within the chute 18 warmed refrigerated air in the chute 18 is recooled to a low operating temperature and streamed into the longitudinal channels between the ribs 8 at the underside of the waisted portion of the chute 18. The arrows indicate the circulation of the refrigerated air in FIG. 1. The refrigerated air streams upwards from the longitudinal channels along the full length of the cargo space 16 enveloping the cargo to collect below the roof panel 4 and is returned upwards into the flared portion of the chute 18 after having picked up the warmth from the cargo space 16 and its cargo. A setting 24 corresponding roughly to the top of the chute 18 (or somewhat lower) ensures that a plenum 26 remains free to receive the warmed refrigerated air below the roof panel 4.

Level with the setting 24 or somewhat thereabove a grating 28 extends over the top of the flared portion of the chute 18 to conventionally prevent foreign objects or clumped substances from entering the chute 18. In addition, the grating 28 is a safety guard against arm and leg access top-down into the chute 18. The cargo space 16 is formed by the front wall 30 of the refrigerating unit 12 configured substantially planar and extending vertical over the height and width of the container in accordance with the dimensioning of the cutout 10, it thereby running parallel to the outer wall 14 of the chute 18 waisting the inner configuration of the chute 18 between its top and bottom portion.

Clearly indicated is how a transverse wall 32 is located below the grating 28 (by roughly 20 to 30 cm in this example embodiment) parallel thereto. Disposed in this arrangement between the front wall 30 and the outer wall 14, on the one hand, and the grating 28 and transverse wall 32, on the other, is a plenum 34 at the top of the chute 18 to receive the since warmed refrigerated air. As shown in FIG. 1a this plenum 34 extends between the side walls practically over the full width thereof in the scope dimensioning the width of the cutout 10. In this arrangement the side clearance is maintained so small that for all practical purposes it can be ignored.

Provided to the left and right of the longitudinal centerline (imaginary line 36 in FIG. 1a) are identical assemblies, only one of which will now be discussed in detail, the other to be imagined mirror-symmetrical at the longitudinal centerline or corresponding center plane of the container.

Accordingly, illustrated in FIG. 1 is just the left-hand portion as shown in FIG. 1a.

The transverse wall 32 is ported in the center, in this case the portion cited on the left, by a port 38 having, as shown here, a circular inner cross-section.

Inserted top-down into the port 38 of the transverse wall 32 is an annular part 40 as will now be detailed with reference to the FIGS. 2a to 2c.

This annular part 40 comprises a cylindrical sleeve 42 inserted in the port 38 and feeds by its flow cross-section the warmed refrigerated air to an axial blower 44 comprising an electrically power gearless two and four pole motor 46 to drive the axial blower 44 optionally at a low or high speed, in other words, an axial blower 44 conventionally powered by an electric motor 46.

Referring now to FIG. 3 there is illustrated how the axial blower 44 also features a ring of blades 48, the novel structure of which will now be detailed in the present context.

But firstly the annular part 40 bottomed by the sleeve 42 will be given more consideration as to its structure at the top of sleeve 42 as shown in FIGS. 2a to 2c.

The complete annular part 40 is an integral injection molded component with a broad choice of known plastics, polyamide or polypropylene expediently reinforced in both cases by glass or carbon fibers being cited just as one example. Selecting this material makes a wall thickness of just 1.5 mm sufficient which as compared to the usual wall thickness of 2 mm when made from aluminum or aluminum alloy constitutes a considerable saving in costs.

The sleeve 42 has a round flow cross-section 50 of maximum diameter, maximum in this case meaning that it corresponds to the diameter of the flow cross-section 50 plus twice the wall thickness of the sleeve 42 in the clearance between the inner side of the outer wall 14 and the inner side of the front wall 30 of the refrigerating unit 12 as is rendered clear in the direction of this clearance in FIG. 2a by the dimension of the flow cross-section with diameter D and twice the dimension d as to the thickness of the sleeve wall.

The top of the sleeve 42 then translates only in both side directions, i.e. in the transverse direction of the container or parallel to its ends into a lateral flow director 52 extending over the full width of the chute 18 by a curvature having a continuously further opening. Each lateral flow director 52 is protracted radially sideways by indi tongues 54 which as is particularly clearly evident from drawing in FIG. 2c are curved back roughly circularly in the direction of the sur of the transverse wall 32 and the crests of which avoid free edges in the air inflow direction. In addition, the tongues 54 are supported by the top of the transverse wall 32 where they also serve as flange-type fasteners. For this purpose the free end 56 of each tongue 54 can be arranged, for example, (not shown) to engage a supporting groove in the top of the transverse wall.

In conclusion FIG. 3 shows how a fan ring 58 of the axial blower 44 is preferably adapted in shape.

The fan ring 58 comprises a hub 60 which can be secured to the output shaft of the drive motor 46 by means of a clip 62.

Distributed equispaced about the circumference of the hub 60 are the blades 48 of the axial blower 44 which as evident from the isometric view in FIG. 3 are curved concave in the conveying direction, they also being twisted inside out in the direction of rotation which is indicated by an arrow in FIG. 3 whilst the conveying direction is to be viewed as passing through the plane of the drawing.

1. A refrigerated container for ships, said container comprising:
a cargo space having a rear wall, a floor area, and a roof area;
a chute formed proximal said rear wall, and extending vertically and substantially over a width of the container, said chute including a transverse wall above which warmed refrigerated air is collected beneath the roof area of the container;
heat exchanger surfaces projecting into said chute for cooling down the warmed refrigerated air, said heat exchanger surfaces forming part of an evaporator circuit;
at least one port with an inserted annular part having a flow cross section is formed in the transverse wall;
a blower conducting warmed refrigerated air to said heat exchanger surfaces through the flow cross section of said annular part, and wherein the refrigerated air cooled down by the heat exchanger surfaces is conducted toward the floor area of the refrigerated container through a bottom of the chute; and
flow directors above the transverse wall extend outwardly on opposite sides of the annular part in the transverse direction of the refrigerated container over the width of said chute, said flow directors including an open curvature laterally directing said warmed refrigerated air into the flow cross section of the annular part drawn in by the blower.

2. The refrigerated container as set forth in claim 1, in which each flow director is configured curved.

3. The refrigerated container as set forth in claim 2, in which each flow director preferably opens outwardly laterally like an opening blossom.

4. The refrigerated container as set forth in claim 1, in which the flow director is curved back to the transverse wall of the chute.

5. The refrigerated container as set forth in claim 4, in which the end of the back curvature is supported by the transverse wall.

6. The refrigerated container as set forth in claim 1, in which t facing the cargo space of the container the space between the flow directors on both sides is maintained open at least partly, preferably fully.

7. The refrigerated container as set forth in claim 1, in which facing the cargo space the space between the flow directors on both sides is formed at least partly by the rear wall of the container.

8. The refrigerated container as set forth in claim 1, in which the flow directors are integral components of the annular part.

9. The refrigerated container as set forth in claim 1, in which the annular part and/or the flow directors are made of injection molded plastics.

10. The refrigerated container as set forth in claim 8, in which the annular part together with the flow directors is configured thin-walled dimensionally stable.

11. The refrigerated container as set forth in claim 1, in which the electric motor of the axial blower is a two and four pole gearless electric motor.

12. The refrigerated container as set forth in claim 1, in which each blower is an axial blower.

13. The refrigerated container as set forth in claim 12, in which the blades of the axial blower are curved concave in the conveying direction.

14. The refrigerated container as set forth in claim 1, in which the flow directors protrude from the top plane of the transverse wall of the chute by 2 to 5 cm, preferably 3 cm.

15. The refrigerated container as set forth in claim 13, in which the depth of the concave configuration of the blades amounts to between ¼ and ½, preferably ⅓ of the height of their protuberance.

16. The refrigerated container as set forth in claim 12, in which the blades of the axial blower are twisted inside out in the direction of rotation.

17. The refrigerated container as set forth in claim 1, in which with a round opening a flow director radially extends 5 to 10 cm, preferably 7 cm from the opening up to the side end.

18. The refrigerated container as set forth in claim 16, in which the twist about the radial axis of the blades is dimensioned in the angular range 5° to 25°, preferably 10°.

19. The refrigerated container as set forth in claim 1 wherein the annular part forms a sleeve inserted in the port of the transverse wall, the flow cross-section of the sleeve forming the flow cross-section for porting the warmed refrigerated air into the chute, the top of the sleeve comprising a flange structure protruding laterally outwards for securing the annular part to the transverse wall, particularly the diameter of the flow cross-section of the sleeve corresponding to the spacing of the front inner wall surfaces of the chute from the rear wall of the container by twice their wall thickness in the tolerance scope and the flange structure is configured at least mainly fragmentary on both sides along the lateral extending direction of the rear wall of the container, in which the side flange structure in the outwards direction adjoining the end of the sleeve initially forms each flow director laterally projected outwards by tongues provided bent back to secure the annular part to the top of the transverse wall.

20. The refrigerated container as set forth in claim 19, in which the flow directors project from the end of the sleeve by a continuously opening curvature.

21. The refrigerated container as set forth in claim 19, in which the flow director formed by the side flange structure is continuously configured fully, or at least predominantly, between the front side of the chute and the front side of the rear wall of the container.
